(19) United States
(12) Patent Application Publication
(10) Pub. No.: US 2025/0089000 A1
(43) Pub. Date: Mar. 13, 2025

(54) METHOD, APPARATUS, AND NETWORK ENTITY FOR POSITIONING TRIGGERING AND CAPABILITY ENHANCEMENTS OVER UNLICENSED BANDS

(71) Applicant: Lenovo (Singapore) Pte. Ltd., New Tech Park (SG)

(72) Inventors: Robin Thomas, Bad Nauheim (DE); Karthikeyan Ganesan, Kronberg im Taunus (DE); Ankit Bhamri, Rödermark (DE); Ali Ali, Kraiburg am Inn (DE); Alexander Golitschek Edler von Elbwart, Darmstadt (DE)

(21) Appl. No.: 18/290,659

(22) PCT Filed: Jul. 14, 2022
(86) PCT No.: PCT/IB2022/056514

§ 371 Date: Jan. 19, 2024

Related U.S. Application Data
(60) Provisional application No. 63/223,466, filed on Jul. 19, 2021.

(51) Int. Cl. H04W 64/00; H04W 16/14; H04W 74/0808

(52) U.S. Cl. CPC H04W 64/00; H04W 16/14; H04W 74/0808

(57) ABSTRACT

Apparatuses, methods, and systems are disclosed for positioning triggering and capability enhancements over unlicensed bands. A method performed in a user equipment (UE) includes detecting an available transmission opportunity or a set of triggering criteria and transmitting a request for assistance data at least partially over an unlicensed carrier based on the available transmission opportunity or the set of triggering criteria.

### FIELD

The subject matter disclosed herein relates generally to wireless communications and more particularly relates to apparatuses, method, and systems for positioning triggering and capability enhancements over unlicensed bands.

### BACKGROUND

In certain wireless communications networks, unlicensed bands may be used.

### BRIEF SUMMARY

Methods for positioning triggering and capability enhancements over unlicensed bands. Apparatuses and systems also perform the functions of the method. In one embodiment, a method performed in a user equipment (UE) includes detecting an available transmission opportunity or a set of triggering criteria and transmitting a request for assistance data at least partially over an unlicensed carrier based on the available transmission opportunity or the set of triggering criteria.

In another embodiment, an apparatus includes a processor, a transceiver in data communication with the processor, and a memory that stores code executable by the processor to detect an available transmission opportunity or a set of triggering criteria and transmit via the transceiver a request for assistance data at least partially over an unlicensed carrier based on the available transmission opportunity or the set of triggering criteria.

In still another embodiment, a network entity includes a transceiver, a processor in communication with the transceiver, and a memory that stores code executable by the processor to receive a request for positioning over unlicensed or licensed assisted access capabilities and transmit a response to the location management function server with unlicensed positioning capabilities.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for positioning triggering and capability enhancements over unlicensed bands;

FIG. 2 is a schematic block diagram illustrating one embodiment of an apparatus that may be used for positioning triggering and capability enhancements over unlicensed bands:

FIG. 3 is a schematic block diagram illustrating another embodiment of an apparatus that may be used for positioning triggering and capability enhancements over unlicensed bands; and

FIG. 4 is a schematic block diagram illustrating a network environment:

FIG. 5A is a first data communication scenario in the network of FIG. 4:

FIG. 5B is a second data communication scenario in the network of FIG. 4:

FIG. 5C is a third data communication scenario in the network of FIG. 4;

FIG. 6 is a communication flow diagram between components of network of FIG. 4:

FIG. 7 is a communication flow diagram between components of network of FIG. 4;

FIG. 8 is a communication flow diagram between components of network of FIG. 4:

FIG. 9 is a communication flow diagram between components of network of FIG. 4:

FIG. 10 is a flow diagram performed by components of network of FIG. 4;

FIG. 11 is a flow diagram of a step performed in the flow diagram of FIG. 10.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

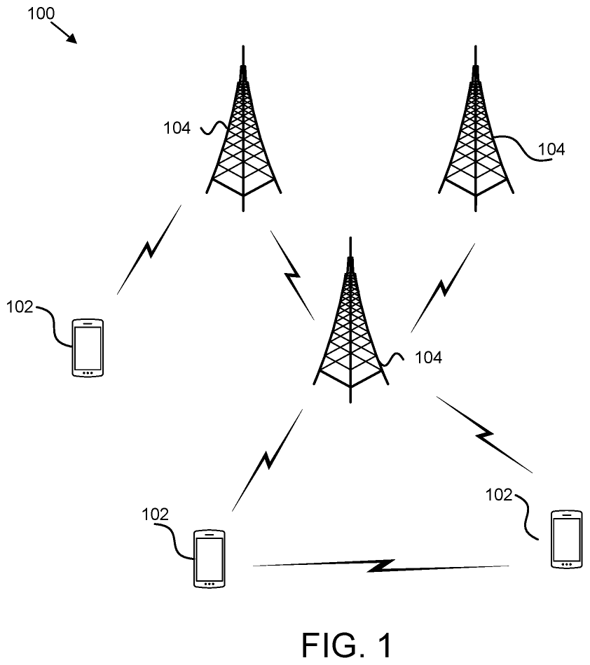

FIG. 1 depicts an embodiment of a wireless communication system 100 for positioning triggering and capability enhancements over unlicensed bands. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 3GPP protocol, wherein the network unit 104 transmits using an OFDM modulation scheme on the DL and the remote units 102 transmit on the UL using a SC-FDMA scheme or an OFDM scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In one embodiment, a remote unit 102 may be used for positioning triggering and capability enhancements over unlicensed bands.

In certain embodiments, a network unit 104 may be used for positioning triggering and capability enhancements over unlicensed bands.

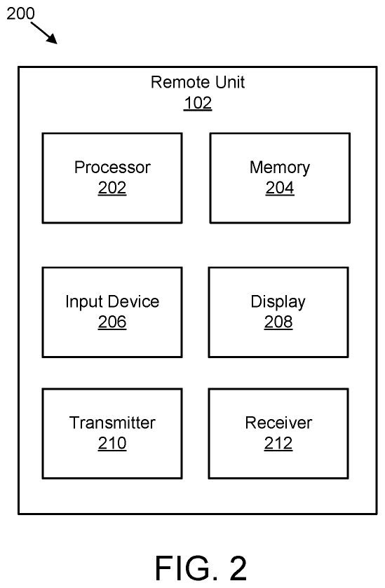

FIG. 2 depicts one embodiment of an apparatus 200 that may be used for positioning triggering and capability enhancements over unlicensed bands. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

The transmitter 210 is used to provide UL communication signals to the network unit 104 and the receiver 212 is used to receive DL communication signals from the network unit 104, as described herein. Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

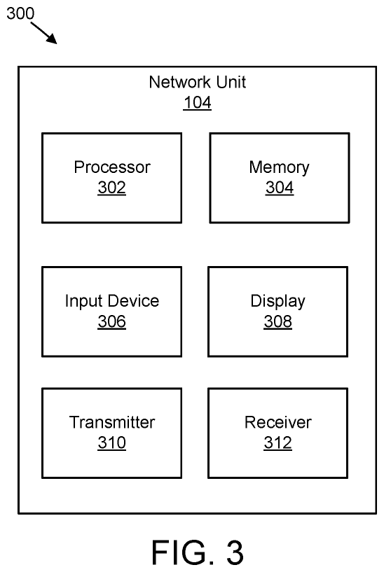

FIG. 3 depicts one embodiment of an apparatus 300 that may be used for positioning triggering and capability enhancements over unlicensed bands. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

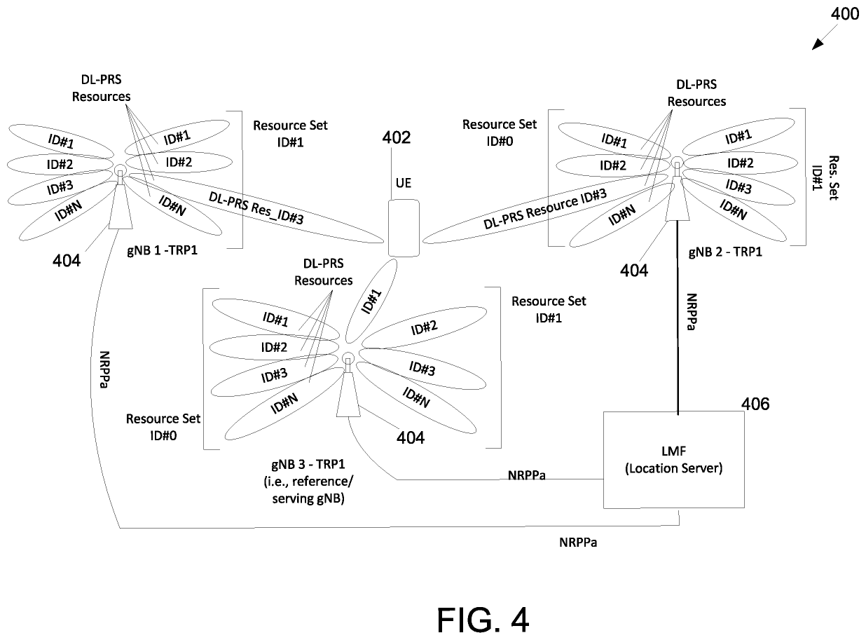

FIGS. 4 through 11 illustrate various embodiments described herein.

There are currently no existing solutions for enabling radio access technology (RAT)-dependent positioning methods over unlicensed carriers (bands) or for enabling a request of assistance data over the unlicensed carriers for user equipment (UE)-based positioning.

Referring to FIG. 4, by way of overview, a positioning reference signal (PRS) can be transmitted by different base stations (serving and neighboring) (network nodes, gNBs) 404 of a network 400 using narrow beams to a UE 402, which is different than long term evolution (LTE) where the PRS is transmitted across a whole cell. In RAT-dependent positioning techniques a location management function (LMF) server 406 provides position estimation to the UE 402 upon request.

In various embodiments, a positioning-related reference signal may refer to a reference signal used for positioning procedures/purposes in order to estimate a location of the target UE 402, e.g. PRS or based on existing reference signals such as sounding reference signal (SRS). A target UE 402 can be referred to as a device/entity to be localized/positioned. In various embodiments, as will be described below, the target UE 402 is configured to request assistance data via an uplink unlicensed (UL U) carrier. The request for assistance data may include a preference to receive the assistance data over licensed, unlicensed bands or combination thereof. Also, the components of the network 400 are configured to transmit unlicensed positioning capabilities between the LMF server 406 and the target UE 402. The unlicensed positioning capabilities include capability information regarding omnidirectional or directional listen-before-talk (LBT) capabilities of the target UE 402. As will be described below the system 400 enables the UE 402 to request positioning assistance data over an unlicensed spectrum (carrier/band). Exchange of capability information enables the LMF server 406 to suitably provision a desired download (DL)-PRS configuration depending on the licensed carrier or unlicensed carrier configuration.

The PRS can be transmitted by different base stations 404 using beams over FR1 and FR2 as illustrated in FIG. 4, which is relatively different when compared to LTE where the PRS was transmitted across the whole cell. The PRS can be locally associated with a PRS Resource ID and Resource Set ID for a base station (TRP) 404. Similarly, UE positioning measurements such as Reference Signal Time Difference (RSTD) and PRS RSRP measurements are made between beams (e.g., between a different pair of DL PRS resources or DL PRS resource sets) as opposed to different cells as was the case in LTE. In addition, there are additional UL positioning methods for the network to exploit in order to compute the target UE's location.

In various embodiments, the UE 402 is configured to request positioning-related reference signal transmission configurations contained within assistance data, which is adapted to a given transmission opportunity as well as to trigger and request for assistance data in timely and efficient manner over the unlicensed band.

### UE-Based Request Assistance Data Using Unlicensed Channel Access

In various embodiments, a location services (LCS) client can trigger the request for assistance data depending on positioning quality of service (QOS) required by an application in order to perform UE-based unlicensed positioning over new radio (NR). The LCS client is an application based entity that supports location services. The LCS client can reside in a UE (in-device applications, e.g., google maps) or in the 5G core network (external LCS clients, e.g., emergency responders, etc.).

Exemplary metrics of the positioning QoS include tight accuracy requirements where the target UE 402 may need to request the LMF server 406 to aggregate carriers over the licensed and/or unlicensed bands to jointly measure the DL-PRS in order the obtain desired positioning measurements, such as reference signal time difference (RSTD), UE receive (Rx)-transmit (Tx) time difference, and DL-PRS reference signal receive power (RSRP) measurements.

In various embodiments, triggering criteria may also include the end-to-end latency of the positioning estimate, which determines time to first fix (TTFF) of the target UE 402. This may also depend on whether the target UE 402 performs an omnidirectional LBT procedure, a directional LBT procedure, or No LBT procedure.

### LBT (Omni-Directional, Directional/Beam-Based)

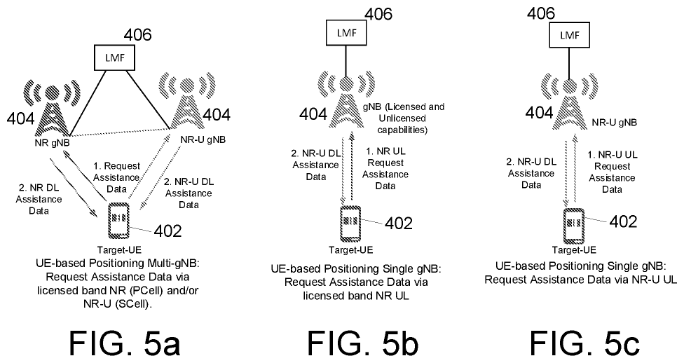

In various embodiments, the target UE 402 is configured to request for positioning assistance data using the preferred bands including licensed and unlicensed bands and using appropriate UL channel access mechanisms to perform UE-based positioning across the defined scenarios in FIG. 5A-C.

Referring to FIG. 5A, a multi-gNB deployment scenario includes the target UE 402 requesting assistance data for performing positioning over both licensed and unlicensed carriers. The request signaling may be transmitted over an NR-U carrier associated with a NR-U capable gNB 404. Referring to FIGS. 5B and C, single gNB deployment scenarios include the request assistance data signaling being transmitted via licensed or unlicensed UL carriers and form a subset of scenarios covered by FIG. 5A.

Referring to FIG. 5B, the UE 402 requests assistance data for performing UE-based positioning using UL licensed carrier and indicating preference for assistance data including DL-PRS resources to be measured over both licensed and unlicensed carriers.

In various embodiments, the request for assistance data of the UL may be transmitted using a target UE-initiated channel occupancy time (COT), which is enabled by either omnidirectional or directional LBT procedures. In the case of omnidirectional LBT, the target UE 402 performs channel sensing (clear channel assessment (CCA)) in all directions (360 degree beam) to determine a transmission opportunity. In the case of directional LBT, the target UE 402 performs CCA in a directional manner, towards the intended gNB 404. In directional LBT, one or multiple beams in specific direction can be utilized.

In various embodiments, the target UE 402 may apply directional LBT instead of omnidirectional LBT, depending on the latency of positioning services defined in positioning QoS. In the case of positioning services with very stringent end-to-end latency requirements, e.g. <10 ms, then No LBT may be applied based on the transmission rules. For positioning services with less stringent end-to-end latency, e.g. <100 ms, then directional LBT may be applied. For positioning services with even more relaxed end-to-end latency requirements, e.g. >1 s, then omnidirectional LBT may be applied.

In various embodiments, the target UE 402 may be configured to autonomously follow a set of LBT/No LBT transmission criteria. This configuration could include a configuration including omnidirectional, directional, or no-LBT procedures. In alternate embodiments, the configuration may be explicit or implicitly provided to the target UE 402. The network 400 may also enable an autonomous configuration based on a positioning service end-to-end latency threshold, e.g. if the latency threshold is not met then the UE 402 overrides any pre-configuration to decide which LBT/no LBT procedure perform.

The assistance data provided by the LMF server 406 to the target UE 402 may be provided over licensed and/or unlicensed carriers (bands). The target UE 402 may receive the assistance data in a dedicated (UE-specific) manner using LTE positioning protocol (LPP) or radio resource control (RRC) signaling. In another implementation, the target UE 402 may also receive the assistance data using positioning broadcast system information block (posSIB) messages or via normal SIBs.

### Short Control Signaling

In various embodiments, the target UE 402 may transmit the request for the assistance data without LBT, if the duration of the transmission complies with a short control signaling exemption on the UL. The short control signaling exemption generally requires that the total duration of any transmissions without performing LBT is no more than a first predetermined duration within a sliding window of a second predetermined duration. For example, the first predetermined duration is 10 ms, and the second predetermined duration is 100 ms. The target UE 402 may be configured whether or not it is allowed to apply the short control signaling exemption (i.e. to forego the LBT procedure) for transmitting the request for the assistance data based on the first predetermined duration and the second predetermined duration. The target UE 402 may be configured to be carrier-specific or band-specific.

### Narrowbeam Transmissions

In this embodiment, the target UE 402 may request the assistance data from the LMF server 406 using no LBT provided that the UL transmission beam of the target UE 402 is below a set/configured beamwidth threshold. This enables a low latency request of the assistance data over the unlicensed band by avoiding the need to perform LBT.

### No LBT

In this embodiment, the target UE 402 may request the assistance data from the LMF server 406 using no LBT. This enables a low latency request of the assistance data over the unlicensed band. This type of transmission depends on the type of environment (e.g. indoor, outdoor) as well as the geographic region in which the target UE 402 is situated.

The request signaling for assistance data may be conveyed using one of the following methods:
LPP signaling to request assistance data from the LMF server 406; or
MAC CE or RRC signaling to request assistance data for the gNB 404, co-located with the LMF server 406 or having a full set or subset of functionality of the LMF server 406.

The aforementioned embodiments may be equally applicable for the transmission of other UL LPP positioning messages such as ProvideCapabilityInformation, ProvideLocationInformation, and error and abort indications.

### Standalone Uplink and Downlink

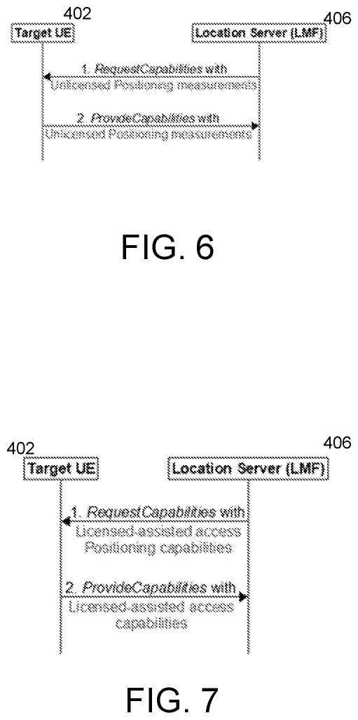

In various embodiments, exchange of capabilites is executed to perform positioning (e.g. RAT-dependent positioning) over the unlicensed band. The LMF server 406 may request the positioning capabilities of the UE 402 designed to receive and process positioning measurements configured for unlicensed band operation. Referring to FIG. 6, an exemplary signaling exchange between the LMF server 406 and the UE 402 includes the request and response capabilities for unlicensed band positioning capabilities. The UE response indicates if and which positioning measurements and associated positioning techniques are capable of being performed over an unlicensed band.

In various embodiments, the UE 402 may also request and receive a response regarding the network's positioning capabilities in terms of licensed and unlicensed carrier support, which would be beneficial for UE-based positioning. An exemplary signaling of the unlicensed positioning capability request can be categorized according to the type of RAT-dependent positioning method, which can be supported for performing positioning over unlicensed carriers.

### Licensed-Assisted Capability

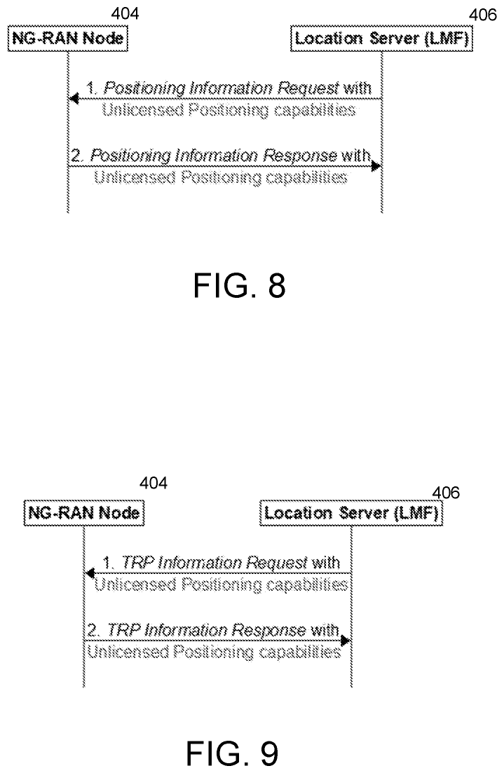

In various embodiments, referring to FIG. 7, the capability exchange is performed using the licensed-assisted access mechanism, where the licensed band is used to schedule the UE 402 (using control plane signaling), e.g., provide the assistance data and measurement configuration via LPP, while the DL-PRS resource can be transmitted over the unlicensed band and can be measured accordingly. This can be a separate capability or UE feature to perform positioning using license-assisted access. Referring to FIG. 8, an exemplary signaling exchange between the LMF server 406 and the UE 402 includes the request and response capabilities for licensed-assisted access positioning capabilities. The licensed-assisted access positioning capability can be categorized according to the type of positioning method being supported, e.g. DL-TDOA, Multi-RTT, etc.

### NG-RAN Capability Validation

In various embodiments, the LMF server 406 performs procedures to determine the unlicensed positioning capabilities of a particular NG-RAN node. The next generation (NG)-RAN node may, for example, include a base station (gNB 404 or ng-eNB). The LMF server 406 may request information related to the unlicensed capability of the desired NG-RAN node in order to determine the capabilities including LBT support of the desired NG-RAN node and thereafter determine the best possible DL-PRS configuration or DL-PRS burst configuration. The exemplary signaling exchange is shown in FIG. 8.

The positioning information response may, for example, include two fields indicated in Table 1. The fields can include a flag indicating whether licensed and/or unlicensed DL-PRS transmissions and unlicensed SRS for positioning reception are supported by the NG-RAN node. Another flag can also indicate if omnidirectional or directional LBT, or both is supported.

TABLE 1
NG-RAN unlicensed capability report to LMF server 406

| | | | IE Type and | |
|---|---|---|---|---|
| IE/Group Name | Presence | Range | Reference | Semantics Description |
| >>Unlicensed Capability | M | | Flag (0, 1) | Flag (0-yes, 1-no) |
| >>LBT Capability | M | | Flag (0, 1, 2, 3) | Flag (0-No support, |
| | | | | 1-Omnidirectional LBT, |
| | | | | 2-Directional LBT, |
| | | | | 3-Both omni and |
| | | | | directional LBT support) |

In various embodiments, referring to FIG. 9, the transmission-reception point (TRP) information request/response signaling can be used to exchange the unlicensed capability between the LMF server 406 and NG-RAN node (e.g. gNB).

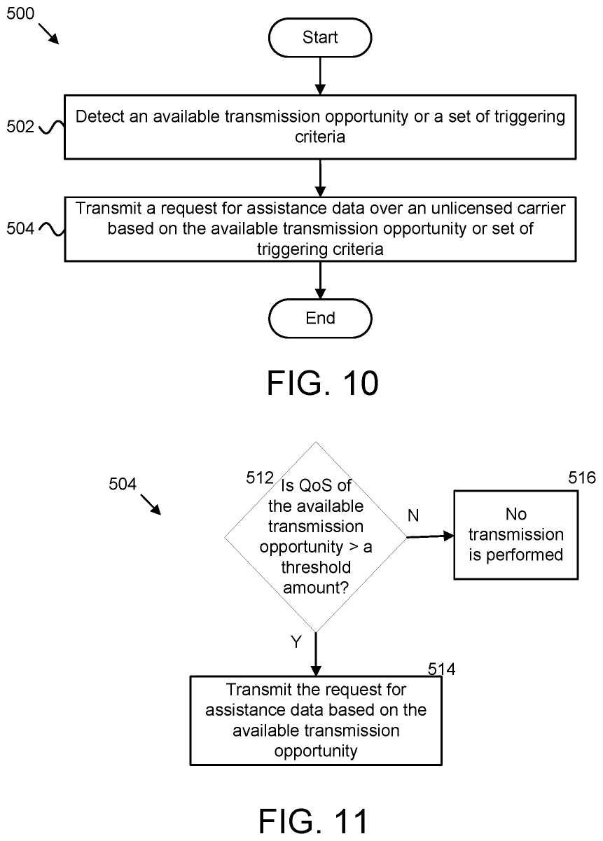

Referring to FIG. 10, a flow diagram of a method 500 performed by a UE is described. At a block 502, the UE detects an available transmission opportunity or a set of triggering criteria. At a block 504, the UE transmits a request for positioning assistance data over an unlicensed carrier based on the available transmission opportunity or set of triggering criteria.

Referring to FIG. 10, a flow diagram of the step at the block 504 of the method 500 is described. At a decision block 512, the UE determines if QoS of the available transmission opportunity is greater than a threshold amount. If the QoS of the available transmission opportunity is not greater than a threshold amount, then, at a block 516, no transmission of a request for positioning assistance data is performed. If the QoS of the available transmission opportunity is greater than a threshold amount, then, at a block 514, the request for positioning assistance data is transmitted based on the available transmission opportunity.

A. An exemplary method performed in a UE includes transmitting a request for positioning assistance data over an uplink unlicensed carrier based on an available transmission opportunity comprising of the desired positioning QoS, and/or transmitting the request over an unlicensed carrier based on a set of triggering criteria that may be provided based on the location service requirements and UE capability.

B. The method according to A, wherein the target UE transmits an uplink request of positioning assistance data based on a set of triggering criteria.

C. The method according to A or B, wherein the triggering criteria is based on the positioning QOS, which may comprise of requirements related to accuracy, latency or a combination thereof.

D. The method according to any of A-C, wherein the target UE performs omnidirectional, directional listen-before-talk or no listen-before-talk procedures based on the triggering criteria.

E. The method according to any of A-D, wherein the no listen-before-talk procedures can include short control signaling uplink transmissions or uplink narrowbeam transmissions that satisfy the beamwidth requirements.

F. The method according to any of A-E, wherein the target UE transmits a request for positioning assistance data using a multi-gNB architecture encompassing licensed and unlicensed transmissions.

G. The method according to any of A-F, wherein the target UE transmits a request for positioning assistance data using a single-gNB architecture capable of receiving licensed and unlicensed transmissions.

H. The method according to any of A-G, wherein the target UE transmits a request for positioning assistance data using a single-gNB architecture capable of only receiving unlicensed transmissions.

I. The method according to any of A-H, wherein the target UE transmits the request for positioning assistance data using LPP or MAC CE or RRC signaling.

J. The method according to any of A-I, wherein the target UE may receive the positioning assistance data in response to the request for positioning assistance data via LPP dedicated signaling or via RRC signaling or via broadcast signaling.

K. The method according to any of A-J, wherein the target UE may receive a request for positioning over unlicensed or licensed assisted access capabilities and thereafter transmit a response to the LMF server 406 with the supported unlicensed positioning capabilities.

L. A method performed in a base station comprising receiving a request for positioning over unlicensed or licensed assisted access capabilities and thereafter transmitting a response to a LMF server with the supported unlicensed positioning capabilities.

M. An apparatus comprising: a processor; a transceiver in data communication with the processor; and a memory that stores code executable by the processor to: detect an available transmission opportunity or a set of triggering criteria; and transmit via the transceiver a request for positioning assistance data at least partially over an unlicensed carrier based on the available transmission opportunity or the set of triggering criteria.

N. The apparatus of M, wherein transmitting is performed via an omnidirectional listen-before-talk (LBT) procedure, a directional LBT procedure, or a no-LBT procedure based on the triggering criteria.

O. A network entity comprising: a transceiver; a processor in communication with the transceiver; and a memory that stores code executable by the processor to: receive a request for positioning over unlicensed or licensed assisted access capabilities; and transmit a response to the location management function server with unlicensed positioning capabilities.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method in performed by a user equipment (UE), the method comprising:
detecting an available transmission opportunity or a set of triggering criteria; and
transmitting a request for positioning assistance data at least partially over an unlicensed carrier based on the available transmission opportunity or the set of triggering criteria.

2. The method of claim 1, wherein transmitting the request for positioning assistance data includes:
determining if at least one of quality of service (QOS) values/parameters of the available transmission opportunity greater than a threshold amount; and
transmitting the request for assistance data responsive to the QoS being greater than the threshold amount.

3. The method of claim 2, wherein the QoS includes an accuracy value and an end-to-end latency value.

4. The method of claim 1, further comprising providing the triggering criteria based on location service requirements and UE capabilities.

5. The method of claim 1, wherein transmitting is performed via an omnidirectional listen-before-talk (LBT) procedure, a directional LBT procedure, or a no-LBT procedure based on the triggering criteria.

6. The method of claim 5, wherein the no-LBT procedure includes control signaling uplink transmissions below a predefined length or uplink transmissions below a predefined beamwidth.

7. The method of claim 1, wherein transmitting the request for positioning assistance data comprises transmitting to a licensed network node and a transmission to an unlicensed network node.

8. The method according to claim 1, wherein transmitting the request for positioning assistance data comprises transmitting the request for positioning assistance data to a single network node capable of receiving licensed and unlicensed transmissions.

9. The method according to claim 1, wherein transmitting the request for positioning assistance data comprises transmitting the request for positioning assistance data to a single network node dedicated to receiving unlicensed transmissions.

10. The method according to claim 1, wherein transmitting the request for positioning assistance data is performed using long term evolution (LTE) positioning protocol (LPP) signaling, medium access control element (MAC CE) signaling, or radio resource control (RRC) signaling; and
further comprising receiving positioning assistance data in response to the request for positioning assistance data via LPP dedicated signaling, RRC signaling, or broadcast signaling.

11. The method according to claim 1, further comprising:
receiving a request for positioning over unlicensed or licensed assisted access positioning capabilities; and
transmitting a response to a location management function (LMF) server with the unlicensed positioning capabilities.

12. A user equipment (UE), comprising:
at least one memory; and
at least one processor coupled with the at least one memory and configured to cause the UE to:
detect an available transmission opportunity or a set of triggering criteria; and
transmit via the transceiver a request for assistance data at least partially over an unlicensed carrier based on the available transmission opportunity or the set of triggering criteria.

13. The UE of claim 12, wherein the transmitting is performed via an omnidirectional listen-before-talk (LBT) procedure, a directional LBT procedure, or a no-LBT procedure based on the triggering criteria.

14. The UE of claim 12, wherein the code is further executable by the processor to:
determine if a quality of service (QOS) value of the available transmission opportunity greater than a threshold amount; and
transmit the request for assistance data responsive to the QoS being greater than the threshold amount,
wherein the QoS includes an accuracy value and an end-to-end latency value.

15. An apparatus for performing a network function,
the apparatus comprising:
at least one memory; and
at least one processor coupled with the at least one memory and configured to cause the apparatus to:
receive a request for positioning over unlicensed or licensed assisted access capabilities; and
transmit a response to the location management function server with unlicensed positioning capabilities.

16. A processor for wireless communication, comprising:
at least one controller coupled with at least one memory and configured to cause the processor to:
detect an available transmission opportunity or a set of triggering criteria; and
transmit via the transceiver a request for assistance data at least partially over an unlicensed carrier based on the available transmission opportunity or the set of triggering criteria.

17. The processor of claim 16, wherein the at least one controller is configured to cause the processor to transmit the request for positioning assistance data by:
determining if at least one of quality of service (QOS) values/parameters of the available transmission opportunity greater than a threshold amount; and
transmitting the request for assistance data responsive to the QoS being greater than the threshold amount.

18. The processor of claim 17, wherein the QoS includes an accuracy value and an end-to-end latency value.

19. The processor of claim 16, wherein the at least one controller is configured to cause the processor to trigger criteria based on location service requirements and UE capabilities.

20. The processor of claim 16, wherein the at least one controller is configured to cause the processor to transmit via an omnidirectional listen-before-talk (LBT) procedure, a directional LBT procedure, or a no-LBT procedure based on the triggering criteria.
